(19) United States
(12) Patent Application Publication
(10) Pub. No.: US 2006/0253288 A1
(43) Pub. Date: Nov. 9, 2006

(54) Audio coding and decoding apparatus, computer device incorporating the same, and method thereof

(76) Inventors: Chung-Shih Chu, Hsinchu (TW); Tsung-Peng Chuang, Hsinchu (TW); Yi-Chang Tu, Tainan City (TW)

Correspondence Address: HARNESS, DICKEY & PIERCE, P.L.C., P.O. BOX 8910, RESTON, VA, 20195, US

(21) Appl. No.: 11/402,863

(22) Filed: Apr. 13, 2006

(30) Foreign Application Priority Data
Apr. 13, 2005 (TW) 094111748

(51) Int. Cl. G10L 21/00

(52) U.S. Cl. 704/500

(57) ABSTRACT

An audio coding and decoding device, which is used to realize the coding and decoding functions, audio coding and decoding device comprising: a first circuit, which is used to perform the first operation of said audio coding and decoding function; a general-purpose processor, which is used to perform the second operation of said audio coding and decoding function according to an instruction set and a software program; and a serial link, which is coupled between said first circuit and said general-purpose processor, and is used to serially transmitting the data between said first circuit and said general-purpose processor.

### CROSS-REFERENCE TO RELATED APPLICATIONS

This non-provisional application claims priority under 35 U.S.C. § 119(a) on Patent Application No(s). 094111748 filed in Taiwan, R.O.C. on Apr. 13, 2005, the entire contents of which are hereby incorporated by reference.

### BACKGROUND OF THE INVENTION

1 Field of the Invention

The invention relates to an audio coding and decoding (CODEC) system and in particular to a high definition audio coding and decoding (HDA CODEC) system.

2. Related Art

Nowadays, the personal computer is not merely utilized as an ordinary operating platform, it is also used as a versatile platform of multimedia applications, such as DVD music, stream music, and home movies. For this purpose, Intel Corporation has developed and announced a High Definition Audio. (HDA) Specification, in the hope of replacing the AC'97 Specification used for years, thus providing a more flexible, dynamic, and cost-saving solution for the high fidelity and high definition musical performance.

In the application of the personal computer, the mainstay of the audio function providing element is transformed from the sound card used in the past to the built-in audio coder-decoder (CODEC) chip on the motherboard. The major function of the CODEC chip is to transform audio data of various formats (usually in the digital format), stored in the storage medium of the computer, into the analog signal and broadcasted through the loudspeaker. In the meantime, the receiving device is used to receive the sound from outside, transform it into a digital format through proper transformation, and then store it in the computer.

In order to optimize the data transformation between digital format and analog format, usually more complicated and sophisticated digital-to-analog and analog-to-digital methods are utilized by the CODEC. Among them, the most prominent example is the sigma-delta digital-to-analog conversion (DAC) and the sigma-delta analog-to-digital conversion (ADC) using sigma-delta modulation algorithm. However, the amount of calculation required by this type of conversion is tremendously large, thus raising the complexity of the CODEC chip and its production cost significantly.

### SUMMARY OF THE INVENTION

In view of the above-mentioned problems and shortcomings of the conventional art, one of the objects of the invention is to provide an audio coding and decoding system, through which at least a part of the audio operations is performed by software.

To achieve the objective of the invention, the invention provides an audio coding and decoding device, which is used to realize audio coding and decoding functions, including the following devices: a first circuit, which is used to execute the first operation of said audio coding and decoding function; a general-purpose processor, which is used to perform the second operation of said audio coding and decoding functions according to an instruction set and a software program, and a serial link, coupled between said first circuit and said general-purpose processor, which is used to sequentially carry out the data transmission between the first circuit and said general-purpose processor.

In order to achieve the objective of the invention, the invention provides a computer device, which is used to realize audio coding and decoding functions, including a printed-circuit-board (PCB); an integrated circuit chip, disposed on said PCB, and used to perform the first operation of said audio coding and decoding function; a general-purpose processor, disposed on the PCB, and used to perform the second operation of said audio coding and decoding function according to an instruction set and a software program, and a data link, coupled between said first circuit and said general-purpose processor, and used to perform the data transmission between said first circuit and said general-purpose processor.

Furthermore, to achieve the objective of the invention, the invention provides an audio coding method, which is utilized to realize the coding function, including the following steps: receiving an analog audio signal; performing the first operation of said audio coding function on said analog audio signal; sequentially transmitting the results of said first operation, and performing the second operation of said audio coding function on the result of said first operation, wherein said second operation is performed by a general-purpose processor according to an instruction set and a software program.

Moreover, to achieve the objective of the invention, the invention provides an audio decoding method, which is utilized to realize a decoding function, including the following steps: receiving a digital audio signal; performing the first operation of said audio decoding function on said digital audio signal; sequentially transmitting the results of said first operation, and performing the second operation of said audio decoding function on the result of said first operation, wherein said second operation is performed by a general-purpose processor according to an instruction set and a software program.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1 is a system block diagram of the audio coding and decoding device incorporated in a personal computer according to the embodiment of the invention;

FIG. 2 is a block diagram of the audio coding and decoding device according to the embodiment of the invention; and

FIG. 3 is a schematic diagram of the data bit stream containing the data bits coming from 16 audio channels.

### DETAILED DESCRIPTION OF THE INVENTION

The purpose, construction, features, and functions of the present invention can be appreciated and understood more thoroughly through the following detailed description with reference to the attached drawings.

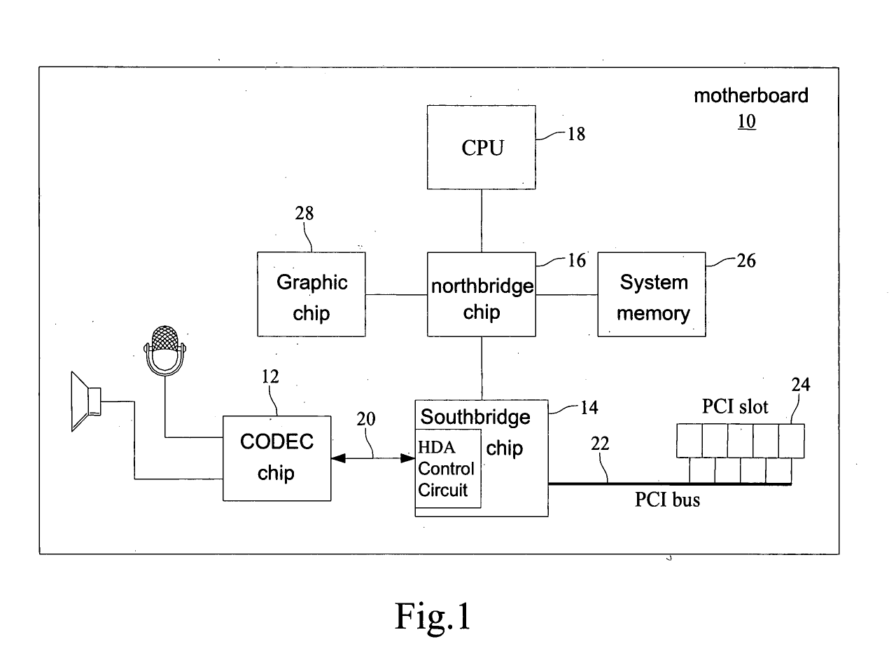

To begin with, please refer to FIG. 1. FIG. 1 is a system block diagram of the audio coding and decoding device incorporated in a personal computer according to an embodiment of the invention, including a motherboard 10, on which are provided a central processor unit (CPU) 18, and a chipset usually composed of a northbridge chip 16 and a southbridge chip 14, which are well known to people skilled in the art. The northbridge chip 16 is coupled to devices such as a system memory 26, and a graphic chip 28, etc., while the southbridge chip 14 is used to communicate with the CPU 18 through the northbridge chip 16, thus achieving the functions of communication with the outside peripheral devices through interfaces such as a PCI bus 22 and a PCI slot 24. The details of such a personal computer are apparent to the people familiar with the computer art, and thus they will not be repeated herein for brevity's sake.

In the above descriptions, a high definition audio (HDA) control circuit is provided in the southbridge chip 14, and is used to communicate with an audio coding and decoding (CODEC) chip 12 through a HDA link 20. Said CODEC chip 12 is connected to an audio receiving device (e.g., a microphone) and an audio broadcasting device (e.g., a loudspeaker), as shown in FIG. 1. As such, in this configuration, the audio functions required by the personal computer system may be realized. However, it should be noted that the HDA link 20, as well known to the people familiar with the art, is a serial link having a much wider frequency band width than traditional parallel links, and is therefore capable of providing high speed data transmission between the CODEC chip 12 and the southbridge chip 14, yet the application of the invention is not limited to the HDA link or serial type link.

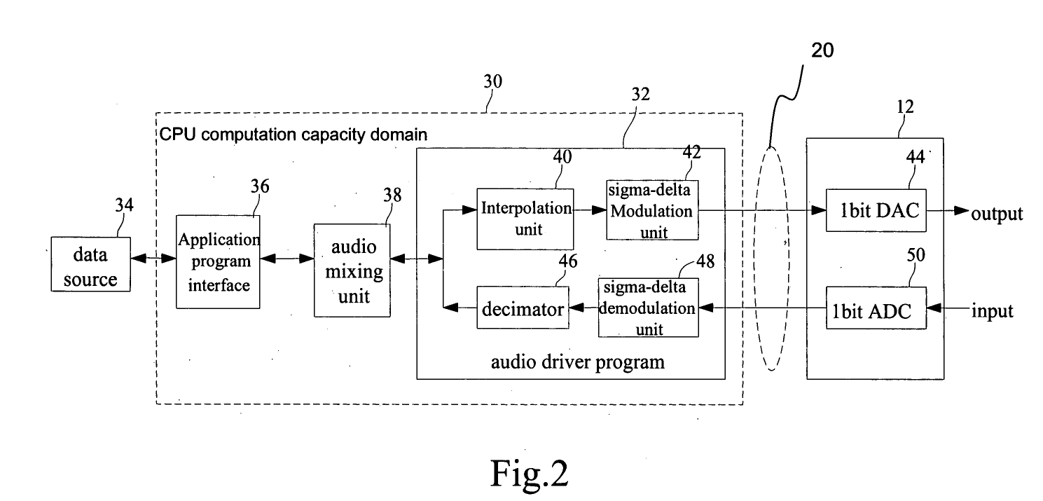

Next, please refer to FIG. 2. FIG. 2 is a block diagram of the structure of the coding and decoding device according to the embodiment of the invention. As shown in FIG. 2, the area enclosed by the dashed fine is the CPU computation capacity domain 30, which denotes the computation capacity generally embodied by and realized through the CPU 18 and its instruction set in cooperation with the driver program and the application program stored in the memory 26 and installed in the personal computer. In this embodiment, the CODEC chip 12 is provided with a 1-bit digital-to-analog converter (DAC) 44 and a 1-bit analog-to-digital converter (ADC) 50, communicating respectively with the computation capacity domain through the HDA link 20. However, the invention is not restricted thereto. The data source 34 may include the various audio data storage medium, for example, the hard disk drive, or the CD drive, which is used to store the audio data of the various file formats, such as the .wav file format, the .mp3 file format, and the DVD file format. However, the invention is not limited thereto.

In the above-mentioned configuration, the process flow of the audio output, or the audio broadcasting, will be described. Firstly, the audio file stored in the data source 34 is read by the application program interface 36, then it is converted into the signal of a digital format such as the signal of pulse coded modulation (PCM) after being processed by the audio mixing unit 38, and is ready for the sigma-delta DAC operation. Next, the interpolation unit 40 is used to perform the up-sampling of the PCM signal, for example, raising the sample frequency to 64 times of its original value, then performing the interpolation operation, for example, performing the low-pass filtering to reduce the impact of the noise to the signal (namely, noise floor suppression). Subsequently, the sigma-delta modulation unit 42 is utilized to perform the well known sigma-delta modulation to concentrate the energy of the noise into the higher frequency band, thus the signal output through the sigma-delta modulation is a series of 1-bit data streams, which are transmitted to the 1-bit DAC 44 through the HDA link 20 to perform the digital-to-analog conversion. And finally, the audio signal is broadcasted through the loudspeaker in the analog format.

Then, the process flow of audio input (namely, the audio recording) is described. Firstly, the analog-signals received by the audio receiving device are converted into a 1-bit data stream through a 1-bit DAC 50, which is transmitted to the sigma-delta demodulation unit 48 through the HDA link 20 to perform the sigma-delta demodulation, so that the energy of the sound is concentrated into the higher frequency band area. Subsequently, the decimator 46 is used to perform a series of down-sampling and filtering, so that the sampling frequency of the output PCM signal is 1/64 that of the original signal. And finally, it is stored as the audio file in the data source 34 through the processing of the audio mixing unit 38 and the application program interface 36.

In this embodiment, the feature of particular importance is that the sigma-delta conversion operation of DAC or ADC is realized through the hardware in corporation with the related software, wherein the 1-bit DAC/ADC is performed by the hardware of the integrated-circuit chip 12, while the sigma-delta modulation and demodulation, the interpolation operation, and the down-sampling are performed by the software of the audio driver program in cooperation with the CPU 18 and its instruction set having the specific operation capability, and the large amount of data bit stream communication is realized by making use of the serial link having a large transmission frequency band width, such as the HDA link.

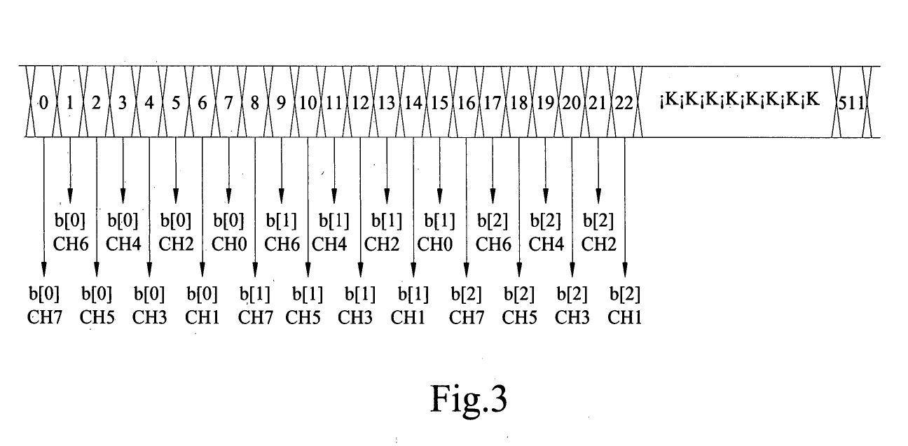

In compliance with the High Definition Audio (HDA) Specification, and with its 48 kHz and 32-bit data transmission capability, the HDA link 20 is capable of transmitting the audio data of 16 channels at most. In the present embodiment, the HDA link 20 is utilized to transmit the stream of data bits coming from 16 channels, and this is realized through the transmission of the data bits of the respective channels on the HDA link arranged in an interleaving manner as shown in FIG. 3. Thus, during the data bit transmission, the first data bit (e.g. b [0])_{CH7}) on one of the 8 channels (e.g. channel CH0) is first transmitted on the data link, then the first data bits of other channels, for example b [0]_{CH6}→b [0]_{CH5}→b [0]_{CH4}→. . . b [0]_{CH0} are transmitted sequentially, until the first data bits of all the channels are transmitted. Then this data bit transmission sequence is repeated from the start all over again, thus the transmission is started with the second data bit of channel CH7 as shown in FIG. 3. As it is proved by the experiment and substantiated by the real applications, in this interleaving arrangement of data bit communication of the channels, the operation capability of CPU may be used to achieve its most efficient utilization. However, it should be noted that, the specific sequence of data bit transmission shown in FIG. 3 is only used to serve as an example, and all the other data bit transmission sequence utilizing the interleaving arrangement of the channels may be considered within the scope of the invention.

Furthermore, in executing the above-mentioned audio signal processing by making use of the personal computer, the various single-instruction multiple-data (SIMD) techniques may be utilized, for example, the MMX, SSE, SSE II, SSE III of the Intel Specification or the 3Dnow of the AMD Specification, as such raising the computation capability of the CPU, thus enabling the software operation capability of the personal computer to support the processing of the audio signal more efficiently, such as the sigma-delta modulation/demodulation.

Knowing the invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An audio coding and decoding device, which is used to realize the audio coding and decoding functions, said audio coding and decoding device comprising:
a first circuit, which is used to perform the first operation of said audio coding and decoding function;
a general-purpose processor, which is used to perform the second operation of said audio coding and decoding function according to an instruction set and a software program; and
a serial link, which is coupled between said first circuit and said general-purpose processor, and is used to perform serially the data transmission between said first circuit and said general-purpose processor.

2. The audio coding and decoding device as claimed in claim 1, wherein
said serial link is in conformity with the high definition audio (HDA) specification.

3. The audio coding and decoding device as-claimed in claim 1, wherein
said first circuit is made as an integrated circuit chip.

4. The audio coding and decoding device as claimed in claim 1, wherein
said first operation executed by said first circuit includes a digital-to-analog conversion and/or an analog-to-digital conversion.

5. The audio coding and decoding device as claimed in claim 1, wherein
said software program includes a portion specifying performing the sigma-delta modulation and/or the sigma-delta demodulation by making use of said general-purpose processor

6. The audio coding and decoding device as claimed in claim 1, wherein
the data transmitted on said serial link include the data from a plurality of audio channels, which are transmitted on said serial link in an interleaving manner.

7. The audio coding and decoding device as claimed in claim 1, wherein
The data transmitted by said serial link include a data stream, comprising a plurality of sequentially transmitted 1-bit data.

8. A computer device, which is used to realize the audio coding and decoding function, said computer device comprising:
a printed-circuit-board;
an integrated circuit chip, provided on said printed-circuit-board, and is used to perform the first operation of said audio coding and decoding function;
a general-purpose processor, provided on said printed-circuit-board, and is used to perform the second operation of said audio coding and decoding function according an instruction set and a software program; and
a data link, coupled between said first circuit and said general-purpose processor, and is used to perform the data transmission between said first circuit and said general-purpose processor.

9. The computer device as claimed in claim 8, wherein
said serial link is in conformity with the high definition audio (HDA) specification.

10. The computer device as claimed in claim 8, wherein
said general-purpose processor is the central processor unit in said computer device.

11. The computer device as claimed in claim 8, wherein
said first operation performed by said integrated circuit chip includes a digital-to-analog conversion and an analog-to-digital conversion.

12. The computer device as claimed in claim 8, wherein
said software program includes a portion specifying performing the sigma-delta modulation and/or the sigma-delta demodulation by making use of said general-purpose processor

13. The computer device as claimed in claim 8, wherein
the data transmitted on said data link include the data coming from a plurality of audio channels, which are transmitted on said data link in an interleaving manner.

14. The computer device as claimed in claim 8, wherein
the data transmitted by said data link includes a data stream, comprising a plurality of sequentially transmitted 1-bit data.

15. The computer device as claimed in claim 8, wherein
said printed-circuit-board is the motherboard of said computer device.

16. An audio coding method used to realize the audio coding function, comprising the steps of:
receiving an analog audio signal;
performing a first operation of said audio coding function on said analog audio signal;
transmitting serially the result of said first operation; and
performing the second operation of said audio coding function on the result of said first operation;
wherein, said second operation is performed by said general-purpose processor according to an instruction set and a software program.

17. The audio coding method as claimed in claim 16, wherein
said second operation is part of a sigma-delta analog-to-digital conversion.

18. An audio decoding method used to perform the audio decoding function, comprising the steps of:
receiving a digital audio signal;
performing a first operation of said audio decoding function on said digital audio signal;
transmitting serially the result of said first operation; and
performing the second operation of said audio decoding function on the result of said first operation;
wherein, said second operation is performed by said general-purpose processor according to an instruction set and a software program.

19. The audio decoding method as claimed in claim 18, wherein
said second operation is part of a sigma-delta digital-to-analog conversion.

20. The audio decoding method as claimed in claim 18, wherein
said digital audio signal is a Pulse-Coded-Modulation (PCM) signal.
